(19) United States
(12) Patent Application Publication
(10) Pub. No.: US 2024/0260595 A1
(43) Pub. Date: Aug. 8, 2024

(54) FERMENTED ONION COMPOSITION

(71) Applicant: Purac Biochem B.V., Gorinchem (NL)

(72) Inventors: David John CHAREST, Lenexa, KS (US); Catalin IANCU, Wageningen (NL); Kumar SAURABH, Lenexa, KS (US); Jarne POSTMUS, Krommenie (NL); Lambertus Henricus Elisabeth ROOZEN, Gorinchem (NL); Jasper MEIJER, Gorinchem (NL); Roel Johannes Adrianus VAN DER VELDEN, Gorinchem (NL); Tithira Tirangika WIMALASENA, Gorinchem (NL); Bogdan Pawel MATYS, Gorinchem (NL); Ayse Nur Pola KOKEN, Gorinchem (NL)

(21) Appl. No.: 18/634,343

(22) Filed: Apr. 12, 2024

Related U.S. Application Data
(63) Continuation of application No. PCT/EP22/78712, filed on Oct. 14, 2022.

(30) Foreign Application Priority Data
Oct. 14, 2021 (WO) PCT/IB2021/000695

(51) Int. Cl. A23B 7/10; A23L 2/08; A23L 3/3472; A23L 19/00; A23L 27/10

(52) U.S. Cl. CPC A23B 7/10; A23L 2/087; A23L 3/3472; A23L 19/09; A23L 27/105

(57) ABSTRACT

The invention provides a fermented onion composition having a dry matter content of at least 8 wt. %, said composition comprising, per gram of dry matter:
75-800 mg acid equivalent of organic acid selected from propionic acid, lactic acid, acetic acid and combinations thereof;
2-200 mg acid equivalent of onion acid selected from selected from citric acid, malic acid, tartaric acid, oxalic acid, pyruvic acid, succinic acid and combinations thereof;
0-150 mg of saccharides selected from fructose, glucose, sucrose and combinations thereof;
0-40 mg of onion protein;
wherein the combination of components a) to d) constitutes 50-95 wt. % of the dry matter that is contained in the composition.

The fermented onion composition of the present invention may suitably be applied as a food ingredient in edible products as it has useful functional properties.

The fermented onion composition of the present invention can be prepared, for instance, by subjecting onion juice and/or onion pulp to membrane filtration to remove e.g. protein, followed by a fermentation step using propionic acid producing bacteria, lactic acid producing bacteria and/or acetic acid producing bacteria.

### CROSS-REFERENCE TO RELATED APPLICATIONS

This application is a continuation of International Patent Application No. PCT/EP2022/078712 filed Oct. 14, 2022, which application claims priority International Patent Application No. PCT/IB2021/000695 filed Oct. 14, 2021, the contents of which are both incorporated herein by reference in their entireties.

### TECHNICAL FIELD OF THE INVENTION

The invention relates to a fermented onion composition having a dry matter content of at least 8 wt. %, said composition comprising, per gram of dry matter:
a) 75-800 mg acid equivalent of organic acid selected from propionic acid, lactic acid, acetic acid and combinations thereof;
b) 2-200 mg acid equivalent of onion acid selected from selected from citric acid, malic acid, tartaric acid, oxalic acid, pyruvic acid, succinic acid and combinations thereof;
c) 0-150 mg of saccharides selected from fructose, glucose, sucrose and combinations thereof;
d) 0-40 mg of onion protein;
wherein the combination of components a) to d) constitutes 50-95 wt. % of the dry matter that is contained in the composition.

The fermented onion composition of the present invention can advantageously be used as an effective, label-friendly food ingredient to increase the overall quality of foods.

The invention further provides a method of preparing a fermented onion composition, comprising:
providing an aqueous liquid having a dry matter content of 2-50 wt. %, wherein at least 80 wt. % of the dry matter is derived from onion;
subjecting the aqueous liquid to membrane filtration using a membrane having a cut-off in the range of 200 to 2,000,000 Da to produce a permeate;
fermenting the permeate with a micro-organism selected from lactic acid producing bacteria, propionic acid producing bacteria, acetic acid producing bacteria and combinations thereof.

### BACKGROUND OF THE INVENTION

Food preservation involves the action taken to maintain foods with the desired properties or nature for as long as possible. Mechanical, physical, chemical, and microbial effects are the leading causes of food deterioration and spoilage. Based on the mode of action, the major food preservation techniques can be categorized as (1) slowing down or inhibiting chemical deterioration and microbial growth, (2) directly inactivating bacteria, yeasts, moulds, or enzymes, and (3) avoiding recontamination before and after processing.

The use of chemicals in foods is a well-known method of food preservation. Wide varieties of chemicals are used in food preservations as additives to control pH, as antimicrobials and antioxidants, and to provide food functionality as well as preservation action. Many legally permitted preservatives in foods are organic acids and esters, including sulfites, nitrites, acetic acid, citric acid, lactic acid, sorbic acid, benzoic acid, sodium diacetate, sodium benzoate, methyl paraben, ethyl paraben, propyl paraben, and sodium propionate. Some of these additives may be perceived as undesirable or less attractive by consumers for instance because they are perceived as “chemical”, “artificial” or “unhealthy”. They may prefer additives that are natural, that can be labelled as a food product instead of an additive, that originate from biological material or that are renewable. Food companies have made good progress in developing products that meet those customer demands, making use of, for instance, vegetables, fruits, herbs and spices or of products fermented with bacteria, yeasts and molds to preserve foods.

Many preservative products are at least partly based on organic acids such as acetic acid, lactic acid and propionic acid. When a weak acid is dissolved in water, equilibrium is established between undissociated acid molecules and charged anions, the proportion of undissociated acid increasing with decreasing pH. The currently accepted theory of preservative action against micro-organisms suggests inhibition via depression of internal cell pH. Undissociated acid molecules are lipophilic and pass readily through the plasma membrane by diffusion. In the cytoplasm, approximately at pH 7.0, acid molecules dissociate into charged anions and protons. These cannot pass across the lipid bilayer and accumulate in cytoplasm, thus lowering pH and inhibiting metabolism. There are several limitations to the value of organic acids as microbial inhibitors in foods:
They are usually ineffective when initial levels of microorganisms are high.
Many microorganisms use organic acids as metabolizable carbon sources.
There is inherent variability in resistance of individual strains.

Another type of compound that can advantageously be employed in preservative products are phenolic compounds. Phenolic compounds are secondary metabolites produced by higher plants which play multiple essential roles in plant physiology and have antimicrobial activity. Quercetin and kaempferol are examples of phenolic compounds, both compounds have a bitter flavour and antimicrobial properties.

WO 2018/106109 describes a natural antimicrobial composition comprising a combination of a buffered food acid component and a nitrite source in the form of a cultured vegetable extract.

JP 2019 103460 describes fermentation of dried onion skins with lactic acid bacteria (25-30° C., 7 days).

KR 2019 0113135 describes a method for producing yeast fermented onion juice using Kluyveromyces lactis. The examples describe fermentation of onion juice using the aforementioned yeast, Lactobacillus casei and Lactobacillus plantarum.

Santas et al. (Onion. A natural alternative to artificial food preservatives, AgroFood industry hi-tech—September/October (2010)—vol 21 n 5) observe that onion is widely used as a food ingredient and it is known as a good source of bioactive compounds, such as sulphur-containing compounds and flavonoids with well-known health beneficial effects, antioxidant and antimicrobial capacities. The authors report that several studies have tested in vitro the effect of organosulfur-containing compounds and have shown that they exhibit marked inhibition against gram positive bacteria of genera Bacillus, Micrococcus, Staphylococcus, Streptococcus, as well as gram negative bacteria, such as Salmonella enteridis or some strains of Escherichia coli. In addition, onion anti-yeast and anti-fungal activity has been mainly attributed to the presence of organosulfur-containing compounds which inhibit the growth of yeast and fungi. The authors further note that the flavonols quercetin and kaempferol are commonly present in notable amounts in onions and are the main non-volatile compounds responsible for their antimicrobial properties. In vitro studies have reported that onion flavonoids can effectively inhibit the growth of gram positive bacteria associated to food spoilage, such as Bacillus cereus, B. subtilis, Staphylococcus aureus, Microcroccus luteus and Listeria monocytogenes.

Dublado et al. (FERMENTED ONION (Allium cepa) JUICE SUPPLEMENTATION TO BROILERS, Journal of Science, Engineering and Technology (2013), 71-77) describes a study in which the effects of fermented onion juice on the growth performance of broilers was investigated. The fermented onion juice was prepared by mixing 1 kg of chopped onion bulbs with 0.5 kg of brown sugar in a pail, covering the pail with a plastic bag with a weight on it. After the 12 hours the weight was removed, and the pail was covered with a manila paper that was tied to the pail with a rubber band. On the seventh day, the juice was collected in a bottle and stored in a cool place.

WO 2021/204995 is not prior published and describes an fermented onion composition comprising saccharides; phenols selected from acid equivalent of gallic acid, acid equivalent of ferulic acid, quercetin, kaempferol and combinations thereof; and acid equivalent of organic acid selected from propionic acid, lactic acid, acetic acid and combinations thereof.

WO 2013/092296 describes a process for preparing a flavour composition having an umami flavour and a monosodium glutamate content of less than 1 wt. % (% weight by total dry matter) comprising the steps of;
a) heating vegetable matter in water at any given temperature to give cooking water containing flavour-active compounds extracted from the vegetable matter;
b) separating the vegetable matter from the cooking water; and
c) concentrating the cooking water to provide the flavour composition.

### SUMMARY OF THE INVENTION

The inventors have developed a novel fermented onion composition with useful functional properties. The fermented onion composition of the present invention can be prepared, for instance, by subjecting onion juice and/or onion pulp to membrane filtration to remove e.g. protein, followed by a fermentation step using propionic acid producing bacteria, lactic acid producing bacteria and/or acetic acid producing bacteria. Onion has a high content of fermentable sugars that can be metabolised into propionic acid by propionic acid producing bacteria, into lactic acid by lactic acid producing bacteria or into acetic acid by acetic acid producing bacteria. Next to that, the fermented onion product has antioxidant activity and can increase textural, sensorial and other functional properties of food products.

Accordingly the invention provides a fermented onion composition having a dry matter content of at least 8 wt. %, said composition comprising, per gram of dry matter:
a) 75-800 mg acid equivalent of organic acid selected from propionic acid, lactic acid, acetic acid and combinations thereof;
b) 2-200 mg acid equivalent of onion acid selected from selected from citric acid, malic acid, tartaric acid, oxalic acid, pyruvic acid, succinic acid and combinations thereof;
c) 0-150 mg of saccharides selected from fructose, glucose, sucrose and combinations thereof;
d) 0-40 mg of onion protein;
wherein the combination of components a) to d) constitutes 50-95 wt. % of the dry matter that is contained in the composition.

The saccharide content of the fermented onion composition is substantially lower than the saccharide content of onions due to the fermentative conversion of these saccharides into organic acid. Also the onion protein content of the fermented onion composition is reduced. The concentration level of organic acid in the fermented onion composition is much higher than that naturally found in onion or onion juice.

The fermented onion composition of the present invention can advantageously be used as an effective, water-soluble and label-friendly food ingredient to increase overall quality of foods, e.g. by acting as a food preservative.

The invention also provides a method of preparing a fermented onion composition, comprising:
providing an aqueous liquid having a dry matter content of 2-50 wt. %, wherein at least 80 wt. % of the dry matter is derived from onion;
subjecting the aqueous liquid to membrane filtration using a membrane having a cut-off in the range of 200 to 2,000,000 Da to produce a permeate;
fermenting the permeate with a micro-organism selected from lactic acid producing bacteria, propionic acid producing bacteria, acetic acid producing bacteria and combinations thereof.

By subjecting the aqueous liquid to membrane filtration a permeate is obtained that is a particularly suitable substrate for the production of a fermented onion composition. Although the inventors do not wish to be bound by theory, it believed that the membrane filtration removes high molecular weight components with anti-microbial activity that are naturally present in onion juice. Furthermore, membrane filtration yields a substrate that is enriched in fermentable sugars, thereby enabling the preparation of a fermented onion composition having a high content of organic acid (by weight of dry matter) and a reduced protein content.

### DETAILED DESCRIPTION OF THE INVENTION

A first aspect of the invention relates to a fermented onion composition having a dry matter content of at least 8 wt. %, said composition comprising, per gram of dry matter:
a) 75-800 mg acid equivalent of organic acid selected from propionic acid, lactic acid, acetic acid and combinations thereof;
b) 2-200 mg acid equivalent of onion acid selected from selected from citric acid, malic acid, tartaric acid, oxalic acid, pyruvic acid, succinic acid and combinations thereof;
c) 0-150 mg of saccharides selected from fructose, glucose, sucrose and combinations thereof;
d) 0-40 mg of onion protein;
wherein the combination of components a) to d) constitutes 50-95 wt. % of the dry matter that is contained in the composition.

The term “acid” as used herein, unless indicated otherwise, encompasses protonated forms of the acid, dissociated forms of the acid and salts of the acid. Thus, the term “citric acid” encompasses, for instance, C₃H₅O(COOH)₃, C₃H₅O(COOH)₂(COO)—, C₃H₅O(COO)³⁻₃, C₃H₅O(COONa)₃ and C₃H₅O(COOH)(COONa)(COO)⁻.

The terminology “mg acid equivalent” as used herein refers to the total amount of a particular acid if the acid were exclusively present in fully protonated from. Thus, 200 mg of sodium propionate equates to 200×74.08/96.06=154.24 mg propionic acid equivalent.

The term “protein” as used herein refers to a polypeptide comprising at least 15 amino acid residues.

The fermented onion composition of the present invention may be provided in the form of a liquid, a paste or a solid (e.g. a powder). Typically, the fermented onion composition has a water content of 0-50 wt. %, more preferably of 0-40 wt. %, more preferably of 0-35 wt. %, most preferably of 0-18 wt. %. The fermented onion composition is preferably a powder.

According to a particularly preferred embodiment, the fermented onion composition is a particulate composition, preferably a particulate composition having an average diameter D[4,3] in the range of 100 to 900 μm, more preferably in the range of 200 to 800 μm and most preferably in the range of 300 to 700 μm. Here the ‘average diameter D[4,3]’ refers to the De Brouckere mean diameter or volume mean diameter and can be defined as the weighted average volume, assuming spherical particles of the same volume as the actual particles. This average diameter is calculated by means of the following equation:

$$D [ 4 , 3 ] = ( \sum {n}_{i} {D}_{i}^{4} ) / ( \sum {n}_{i} {D}_{i}^{3} )$$

wherein:
Dᵢ=mean particle size in size class i;
nᵢ=number of particles in size class i

In a further preferred embodiment, at least 80 wt. % of the particulate composition has a particle size in the range of 40 to 1500 μm, more preferably in the range of 100 to 1200 μm, most preferably in the range of in the range of 200 to 1,000 μm. The mass weighted average particle size can suitably be determined using laser diffraction (Malvern Mastersizer 3000).

The fermented onion composition preferably contains, per gram of dry matter, 75-500 mg acid equivalent of organic acid selected from propionic acid, lactic acid, acetic acid and combinations thereof.

The fermented onion composition typically contains, per gram of dry matter, 0-120 mg, more preferably 0-100 mg and most preferably 0-90 mg of saccharides selected from fructose, glucose, sucrose and combinations thereof.

According to a particularly preferred embodiment, the fermented onion composition contains 3-160 mg acid equivalent, more preferably 5-120 mg acid equivalent, even more preferably 10-100 mg acid equivalent and most preferably 15-90 mg acid equivalent of onion acid selected from citric acid, malic acid, tartaric acid, oxalic acid, pyruvic acid, succinic acid and combinations thereof.

The combination of components a) to c) (organic acid, onion acid and saccharides) typically constitutes at least 50 wt. % of the dry matter that is contained in the composition. More preferably, the combination of components a) to c) constitutes 52-95 wt. % of the dry matter that is contained in the composition. Most preferably, the combination of components a) to c) constitutes 55-90 wt. % of the dry matter that is contained in the composition.

The combination of components a) to d) (organic acid, onion acid, saccharides and onion protein) constitutes 50-95 wt. % of the dry matter that is contained in the composition. Preferably, the combination of components a) to d) constitutes at least 60 wt. % of the dry matter that is contained in the composition, more preferably at least 70 wt. % of the dry matter that is contained in the composition.

In one embodiment of the invention, the composition contains per gram of dry matter not more than 800 mg lactic acid equivalent. More preferably, the composition contains per gram of dry matter 200-750 mg lactic acid equivalent. Most preferably, the composition contains per gram of dry matter 400-700 mg lactic acid equivalent.

In another embodiment of the invention, the composition contains per gram of dry matter 200-450 mg lactic acid equivalent. More preferably, the composition contains per gram of dry matter 100-420 mg lactic acid equivalent. Most preferably, the composition contains per gram of dry matter 150-400 mg lactic acid equivalent.

In one embodiment of the invention, the composition contains per gram of dry matter not more than 800 mg propionic acid equivalent. More preferably, the composition contains per gram of dry matter 200-750 mg propionic acid equivalent. Most preferably, the composition contains per gram of dry matter 400-700 mg propionic acid equivalent.

In another embodiment, the composition contains per gram of dry matter 75-450 mg propionic acid equivalent. More preferably, the composition contains per gram of dry matter 125-400 mg propionic acid equivalent. Most preferably, the composition contains per gram of dry matter 175-350 mg propionic acid equivalent.

In a preferred embodiment, the present composition contains both propionate in the aforementioned concentration and acetate. Besides propionate, the composition typically contains per gram of dry matter 10-150 mg acetic acid equivalent, more preferably 20-130 mg acetic acid equivalent and most preferably 30-110 mg acetic acid equivalent.

In yet another embodiment of the invention the composition contains, per gram of dry matter, not more than 450 mg acetic acid equivalent. More preferably, the composition contains per gram of dry matter 100-420 mg acetic acid equivalent. Most preferably, the composition contains per gram of dry matter 150-400 mg acetic acid equivalent.

The fermented onion composition typically contains, per gram of dry matter, 0-80 mg of onion protein, preferably 0-60 mg of onion protein, more preferably 0-40 mg of onion protein, more preferably 0-30 mg of onion protein, more preferably 0-20 mg of onion protein, yet more preferably 0-10 mg of onion protein, even more preferably 0-5 mg onion protein and most preferably 0-2 mg of onion protein.

According to another preferred embodiment, the composition contains less than 0.5 mg onion protein per mg acid equivalent of the organic acid, more preferably less than 0.3 mg onion protein per mg acid equivalent of the organic acid and most preferably less than 0.1 mg onion protein per mg acid equivalent of the organic acid.

Preferably, the composition contains less than 5 mg onion protein per mg acid equivalent of the onion acid, more preferably less than 3 mg onion protein per mg acid equivalent of the onion acid and most preferably less than 1 mg onion protein per mg acid equivalent of the onion acid.

The antimicrobial activity of the fermented onion composition may be further enhanced by using fermentation to not only produce organic acid, but also bacteriocin. The bacteriocin may be one or more bacteriocins selected from the group of nisin, subtilin, cytolysin, variacin, sakacin, pediocin, curvaticin, enterocin and lactacin. More preferably, the bacteriocin may be one or more selected from the group of nisin, sakacin, pediocin and lactacin. Most preferably the bacteriocin is nisin. According to a preferred embodiment, the composition contains per gram of dry matter 5,000-500,000 IU nisin equivalent activity. More preferably, the composition contains per gram of dry matter 10,000-400,000 IU nisin equivalent activity. Most preferably, the composition contains per gram of dry matter 50,000-300,000 IU nisin equivalent activity.

Since lactic acid and bacteriocin can both be produced by lactic acid producing bacteria, in a preferred embodiment, the fermented onion composition contains both lactic acid and bacteriocin. In an even more preferred embodiment, the fermented onion composition contains lactic acid and nisin.

The fermented onion composition typically has a total nitrogen content of not more than 40 mg per gram of dry matter, preferably not more than 30 mg, more preferably not more than 15 mg per gram of dry matter, even more preferably a total nitrogen content of 0.01-12 mg per gram of dry matter and most preferably a total nitrogen content of 0.015-8 mg per gram of dry matter. The total nitrogen content is suitably determined using the Kjeldahl method.

The fermented onion composition typically has a total nitrogen content of not more than 90 mg per gram of acid equivalent of organic acid selected form propionic acid, lactic acid, acetic acid and combinations thereof, more preferably a total nitrogen content of 0.1-70 mg per gram of acid equivalent of organic acid selected form propionic acid, lactic acid, acetic acid and combinations thereof and even more preferably a total nitrogen content of 1-50 mg per gram of acid equivalent of organic acid selected form propionic acid, lactic acid, acetic acid and combinations thereof. Most preferably, the fermented onion composition has a total nitrogen content of not more than 30 mg per gram, preferably not more than 20 mg per gram, more preferably not more than 10 mg per gram, of acid equivalent of organic acid selected form propionic acid, lactic acid, acetic acid and combinations thereof.

Preferably, not more than 90 wt. %, more preferably not more than 50 wt. % and most preferably not more than 25 wt. % of the protein contained in the fermented onion composition is onion protein.

According to a further preferred embodiment at least 40 wt. %, more preferably at least 50 wt. %, even more preferably at least 70 wt. % and most preferably at least 80 wt. % of the dry matter contained in the fermented onion composition is derived from onion. Organic acid formed by fermentative conversion of onion derived saccharides is regarded as derived from onion.

The fermented onion composition of the present invention typically contains appreciable amounts of low molecular weight components that are naturally present in onions, such as onion acids, sulphur-containing compounds, aldehydes, ketones.

According to a particularly preferred embodiment, high molecular weight phenolic compounds that naturally occur in onion have been removed from the fermented onion composition according to the present invention. Removal of these components prior to fermentation enables the efficient production of fermented onion compositions having a high content of organic acid. Although the inventors do not wish to be bound by theory, it is believed that the high molecular weight phenolic compounds have antimicrobial activity that hampers the growth and/or metabolic activity of the bacteria used in the production of the fermented onion composition. Preferably, the fermented onion composition contains, per gram of dry matter, 0-2 mg, preferably 0-1.5, more preferably 0-1.3 mg, even more preferably 0.1-1.2 mg and most preferably 0.2-1.1 mg of phenolic compounds. The concentration of phenolic compounds can suitably be determined using the Phenols LCK cuvette test HALCK345 (ex Hach Lange).

The fermented onion composition preferably comprises per gram of dry matter, 0.05-30 mg acid equivalent of citric acid, more preferably 0.15-25 mg acid equivalent of citric acid and most preferably 0.25-20 mg acid equivalent of citric acid.

The fermented onion composition preferably comprises per gram of dry matter, 0.2-30 mg acid equivalent of malic acid, more preferably 0.5-25 mg acid equivalent of malic acid and most preferably 1-20 mg acid equivalent of malic acid.

The fermented onion composition preferably comprises per gram of dry matter, 1-150 mg acid equivalent of gallic acid, more preferably 3-125 mg acid equivalent of gallic acid and most preferably 5-100 mg acid equivalent of gallic acid.

The fermented onion composition preferably comprises per gram of dry matter 0.05-8 mg acid equivalent of ferulic acid, more preferably 0.15-7 mg acid equivalent of ferulic acid and most preferably 0.25-6 mg acid equivalent of ferulic acid.

Cellular material from the micro-organisms used in the preparation of the fermented onion composition is typically present in said composition. Accordingly, in a preferred embodiment, the composition contains cellular material from lactic acid producing bacteria, propionic acid producing bacteria and/or acetic acid producing bacteria. More preferably, the composition contains cellular material from lactic acid producing bacteria and/or Propionibacterium.

According to another preferred embodiment, the bulk of dry matter contained the fermented onion composition is water-soluble. Preferably, at least 95 wt. % of the composition is dissolved at a temperature of 20° C. when the composition is diluted with distilled water to a dry matter content of 5 wt. %.

The fermented onion composition of the present invention is preferably obtainable by, even more preferably obtained by the preparation method described below.

Another aspect of the invention relates to a method of preparing a fermented onion composition, comprising:
providing an aqueous liquid having a dry matter content of 2-50 wt. %, wherein at least 80 wt. % of the dry matter is derived from onion;
subjecting the aqueous liquid to membrane filtration using a membrane having a molecular weight cut off of 200-2,000,000 Da to produce a permeate;
fermenting the permeate with a micro-organism selected from lactic acid producing bacteria, propionic acid producing bacteria, acetic acid producing bacteria and combinations thereof.

According to a particularly preferred embodiment, the aforementioned preparation method yields a fermented onion composition as defined herein before.

The aqueous liquid employed in the preparation method preferably comprises onion juice, onion pulp or a combination thereof. Onion juice may be provided in the form of concentrated onion juice or onion juice powder. Onion pulp may suitably be provided in the form of onion powder. The powder or concentrate may be diluted with water to obtain the aqueous liquid with 2-50%, preferably 2-40% dry matter as a starting material for the fermentation.

The aqueous liquid preferably contains 4-40 wt. % dry matter and 96-60 wt. % water. More preferably, the aqueous liquid contains 8-30 wt. % dry matter and 92-70 wt. % water.

In a preferred embodiment, at least 85 wt. %, more preferably at least 88 wt. % and most preferably at least 90 wt. % of the dry matter of the aqueous liquid is derived from onion.

Preferably, at least 80 wt. % of the dry matter of the aqueous liquid is provided by onion juice and/or onion pulp. More preferably, at least 80 wt. % of the dry matter of the aqueous liquid is provided by onion juice, most preferably by concentrated onion juice having a water content of less than 40 wt. %.

The aqueous liquid typically contains, calculated by weight of dry matter, at least 40 wt. %, more preferably at least 50 wt. % and most preferably at least 55 wt. % of saccharides selected from fructose, glucose, sucrose and combinations thereof.

The total nitrogen content of the aqueous liquid, calculated by weight of dry matter, preferably lies in the range of 0.15-3.5 wt. %, more preferably in the range of 0.2-3.0 wt. % and most preferably in the range of 0.3-2.5 wt. %. The total nitrogen content of the aqueous liquid is suitably determined using the Kjeldahl method.

According to a particularly preferred embodiment, the aqueous liquid is subjected to membrane filtration using a membrane having a molecular weight cut off of 400-1,000,000 Da, more preferably of 600-500,000 Da and most preferably of 800-100,000 Da. The molecular weight cut-off of a membrane is defined as the minimum molecular weight of a solute that is 90% retained by the membrane, according to the French Standard NF X 45-103 (AFNOR. Norme Francaise NFX45-103; French Association of Normalization: Paris La Defense, France, 1997).

The method according to the present invention may suitably contain a membrane filtration step with a membrane having a cut-off of 1,000-500,000 Da, more preferably of 2,000-100,000 Da, even more preferably of 2,500-40,000 Da, most preferably of 3,000-30,000 Da. This membrane filtration step may be carried out by employing an ultrafiltration membrane as the membrane prior to the fermentation step. In one preferred embodiment, a heat sterilisation step is employed between the membrane filtration step and the fermentation step. In another preferred embodiment, the membrane filtered aqueous liquid is subjected to fermentation without an intermediate heat sterilization step.

The present invention also encompasses an embodiment in which an ultrafiltration step is carried out after fermentation and wherein the membrane filtration prior to fermentation is carried out using membrane having a substantially higher cut-off. The inventors have found that the use of an ultrafiltration step offers the advantage that undesirable flavour notes are removed and that a more bland tasting fermented onion composition is obtained.

Membrane filtration further offers the advantage that it can be used to produce a disinfected composition. Unlike heat sterilisation, membrane filtration does not give rise to off-flavour formation resulting from e.g. heat-induced Maillard reactions.

The membrane filtration of the aqueous liquid preferably removes at least 20 wt. %, more preferably at least 40 wt. % and most preferably at least 80 wt. % of the protein that is contained in the aqueous liquid.

Preferably, the membrane filtration removes at least 3%, more preferably at least 6% and most preferably at least 10% of the total nitrogen content of the aqueous liquid. The total nitrogen content of the aqueous liquid is suitably determined using the Kjeldahl method.

The permeate obtained by the membrane filtration preferably contains, calculated by weight of dry matter, at least 50 wt. %, more preferably at least 60 wt. %, more preferably at least 70 wt. %, even more preferably at least 80 wt. % and most preferably at least 90 wt. % of saccharides selected from fructose, glucose, sucrose and combinations thereof.

The permeate obtained by the membrane filtration may suitably be concentrated before it is fermented. Concentration may be achieved by employing one or more of the following concentration techniques: evaporation, reverse osmosis, nanofiltration and freeze concentration.

The permeate that is fermented in the present method preferably has a dry solids content of 10-50 wt. %, more preferably of 15-45 wt. % and most preferably of 20-40 wt. %.

The lactic acid producing bacteria that are employed in accordance with the present invention preferably are lactic acid bacteria.

The propionic acid producing bacteria that are employed in accordance with the present invention preferably are Propionibacterium.

The acetic acid producing bacteria that are employed in accordance with the present invention preferably are acetic acid bacteria.

In an advantageous embodiment of the present invention the aqueous liquid or permeate is treated with invertase prior to fermentation. Invertase treatment converts sucrose into glucose and fructose which may be more effectively metabolised by certain strains of lactic acid producing bacteria and/or Propionibacterium.

Onion acid selected from citric acid, malic acid, gallic acid and combinations thereof is preferably present in the aqueous liquid in a concentration, per gram of dry matter, of 3-120 g acid equivalent, more preferably 5-110 mg acid equivalent, even more preferably of 10-100 mg acid equivalent and most preferably of 15-90 mg acid equivalent.

Preferably, the aqueous liquid contains, calculated by weight of dry matter, 0.02-3 wt. % phenolic compounds, more preferably 0.05-2.5 wt. % phenolic compounds and most preferably 0.1-2 wt. % phenolic compounds.

According to a preferred embodiment, the permeate is fermented with a micro-organism selected from lactic acid producing bacteria, Propionibacterium and combinations thereof.

In a preferred embodiment, the permeate is fermented with a micro-organism selected from the group of Propionibacterium acidipropionici, Bacillus coagulans, Lactobacillus plantarum, Propionibacterium freudenreichii and Propionibacterium shermani.

Typically, the permeate is inoculated with at least 0.1% w/w of a pre-culture of the micro-organism. More preferably the permeate is inoculated with 0.5-40% w/w of a pre-culture, most preferably 1.0-30% w/w of a pre-culture of the micro-organism.

The inoculated permeate is preferably incubated at a temperature in the range of 20-70° C., more preferably at a temperature of 25-65° C. for at least 12 hours to produce the fermented permeate.

According to another preferred embodiment, the inoculated permeate is incubated under anaerobic conditions.

Typically, incubation is continued until the incubated permeate contains, calculated by dry matter, 10-80 wt. % acid equivalent of organic acid selected from propionic acid, lactic acid, acetic acid and combinations thereof, preferably 10-80 wt. % acid equivalent of organic acid selected from propionic acid, lactic acid and combinations thereof.

In one embodiment of the present invention base is added during and/or after incubation so as to neutralise at least a part of the organic acid that is formed during incubation. Preferably, sufficient base is added to increase pH of the fermented permeate to 5.0 or more, more preferably to increase pH of the fermented permeate to 5.5-7.5.

After incubation, the fermented permeate is preferably sterilised, e.g. by means of UHT sterilisation.

According to a preferred embodiment the fermented permeate is subjected to a second membrane filtration using a membrane having a cut-off in the range of 200 to 2,000,000 Da, more preferably having a cut-off in the range of 1,000-500,000 Da, even more preferably an ultrafiltration membrane having a cut-off in the range of 2,000-100,000 Da. This second membrane filtration advantageously removes the fermentation biomass.

The fermented permeate is preferably concentrated to a dry matter content of at least 50 wt. %, more preferably of at least 60 wt. % after incubation and after optional further process steps such as an extra membrane filtration.

According to a particularly preferred embodiment, the fermented permeate is dried to produce a dry powder having a water content of not more than 18 wt. %, preferably of not more than 15 wt. %. Drying techniques that may suitably be employed are spray drying, drum drying and freeze drying. After drying, the dried fermented permeate may suitably be subjected to additional processing steps such as milling, sieving and granulation. Most preferably, the fermented permeate is dried by means of spray drying.

Another aspect of the present invention relates to a fermented onion composition that is obtained by the method of the present invention.

A further aspect of the invention relates to a process of preparing a food product or a beverage, said process comprising combining the fermented onion composition according to the present invention with one or more other ingredients. The fermented onion composition of the present invention is particularly suitable for preserving food products such as meat products, savoury products such as soups and sauces, salads and (vegetable) beverages.

Preferably, the process of preparing a food product or a beverage comprises incorporating the fermented onion composition in a concentration of 0.1-10%, more preferably in a concentration of 0.2-5% by weight of the final food product or the final beverage.

Yet another aspect of the invention relates to the use of the fermented onion composition of the present invention as a food preservative. This use typically comprises mixing of the fermented onion composition with one or more other ingredients of the product that requires preservation.

Yet another aspect of the invention relates to the use of the fermented onion composition to prevent microbial spoilage of food products. Yet another aspect of the invention relates to the use of the fermented onion composition to improve the sensory properties of a food product or a beverage, preferably of meat products.

In yet another aspect of the invention relates to a process of preserving a food product, while maintaining and/or improving the sensory properties of the food product, by incorporating the fermented onion composition of the present invention in the food product, preferably by incorporating the fermented onion composition that is obtained by the method of the present invention in the food product.

Preferably, the food product in the process of preserving a food product, is a meat product. More preferably, the food product in the process of preserving a food product, is a meat product and the sensory properties of the food product relate to the color of the meat product.

It was surprisingly found that the fermented onion composition may be used for preserving the fresh color of meat products. The meat color stays stable despite relatively low levels of fermented onion composition to be incorporated into the final meat product and the meat color is equal or even better compared to when solely unfermented onion extract is incorporated into the final product.

The fermented onion composition is preferably incorporated in a concentration of 0.1-10%, more preferably 0.2-5%, by weight of the final meat product.

The invention is further illustrated by the following non-limiting examples.

### EXAMPLES

### Example 1

Experiments were conducted using onion juice as a starting material. A specification of the onion juice is provided in Table 1.

TABLE 1

| Dry matter | 67-76 | wt. % |
|---|---|---|
| Brix (20° C.) | 72-74° | |
| pH | 4.2-5.1 | |
| Solubility | Fully soluble in water | |
| Glucose | 70-150 | g/kg |
| Fructose | 60-190 | g/kg |
| Sucrose | 1-28 | g/kg |
| Protein | 58-108 | g/kg |

To prepare an onion juice stock solution, 1 part by weight of onion juice concentrate was diluted with 2 parts by weight of demineralised water. Next, the diluted onion juice was UHT sterilised and cooled down to ambient temperature. The pH of the resulting medium was ˜4.6.

The sterilised onion juice stock solution was filtrated in a cross flow lab membrane filtration set up (Pall UMP-1047R) with a microfiltration membrane having a pore size of 0.2 μm (polyvinyldenefluoride membrane, 0.09 m²) at ambient temperature. From 2300 ml of feed, 1300 ml of permeate was produced. The feed and permeate were analysed to determine dry matter content, nitrogen content (Kjeldahl) and phenolic compounds content (LCK345 kit, ex Hach Lange). The results are shown in Table 2.

TABLE 2

| | Dry matter | Total N | Phenolic compounds |
|---|---|---|---|
| | [%] | [% DM] | [% DM] |
| Stock | 23.8 | 1.790 | 0.21 |
| Permeate 1a | 21.5 | 1.786 | 0.19 |

The microfiltration step resulted in an increase of the sugar content and a reduction of the protein and phenolic compounds content in the dry matter.

In another membrane filtration test, the sterilized onion juice stock solution was first treated with invertase by adding 1 ml/kg of an invertase solution and incubating overnight. Next, the invertase treated onion juice stock solution was filtrated in a crossflow lab membrane filtration set up (MMS, SW18-S) with 3 ultrafiltration membranes in series, each with a molecular weight cut-off of 5 kDa (Atech innovations GmbH, Al₂O₃/ZrO₂) at ambient temperature. From 6,055 g of feed, 4,459 g of permeate was produced. The feed, retentate and permeate were analysed to determine dry matter content, nitrogen content (Kjeldahl) and phenolic compounds content (LCK345 kit, ex Hach Lange). The results are shown in Table 3.

TABLE 3

| | Dry matter | Total N | Phenolic compounds |
|---|---|---|---|
| | [%] | [% DM] | [% DM] |
| Feed 1b | 24.5 | 1.72 | 0.21 |
| Retentate 1b | 28.0 | 1.77 | 0.29 |
| Permeate 1b | 22.1 | 1.68 | 0.16 |

The smell of the feed, the permeate and the retentate was evaluated by an expert panel. The results are summarized in Table 4.

TABLE 4

| | Smell |
|---|---|
| Feed 1b | Sharp, bitter, dusty, metallic, old, sulfuric |
| Permeate 1b | Soft: sweet, onion concentrate, marmite, |
| | brown, gravy, a bit flowery |
| Retentate 1b | Sharp, strong bitter, concentrated, |
| | unfresh, brown, caramelized |

The permeate had a smell that was perceived as more pleasant than that of the feed and the retentate.

### Example 2

The onion juice stock solution of Example 1 was fermented using Bacillus coagulans (deposited by Corbion NV at the DSMZ depository institution (German collection of microorganisms and cell cultures) 20 Mar. 2020 and having a deposit number DSM 33469). The fermentations were carried out in either batch or fed-batch mode, but all directed at obtaining a final lactate concentration of 8.0-8.2% w/v.

In batch mode, 1 part by weight of the stock solution was mixed with 1.05 parts by weight of a fermentation mixture comprising yeast extract, vitamin and mineral mix, inoculum, invertase and demineralized water.

In fed-batch mode, the starting medium in the fermenter contained 50% of the stock solution, whilst the aforementioned fermentation mixture was added in the same amount as in the batch experiment, such that the weight ratio of stock solution to fermentation mixture was 1:2.1 at the start of fermentation. Three different substrates (fed-batch materials) were gradually introduced into the fermenter during the fed-batch experiment:
Stock solution
Permeate 1a of Example 1
A glucose solution (containing fully hydrolysed corn starch)

The set-up of the fermentation experiments is depicted in Table 5 (fermentations were carried out in duplicate).

TABLE 5

| | Batch or | | |
|---|---|---|---|
| Experiment | fed-batch | Starting material | Fed-batch material |
| 1 | Batch | Onion juice stock | — |
| 2 | Fed-batch | Onion juice stock | Onion juice stock |
| 3 | Fed-batch | Onion juice stock | Permeate 1a |
| 4 | Fed-batch | Onion juice stock | Glucose |

The Onion juice stock, Permeate 1a and Glucose solution were analysed to determine dry matter content, nitrogen content (Kjeldahl) and phenolic compounds content (LCK345 kit, ex Hach Lange). The results are shown in Table 6.

TABLE 6

| | Dry matter | Total N | Phenolic compounds |
|---|---|---|---|
| Product | [%] | [% DM] | [% DM] |
| Stock | 23.8 | 1.790 | 0.21 |
| Permeate 1a | 21.5 | 1.786 | 0.19 |
| Glucose solution | 50 | 0 | 0 |

The pH of the fermentation medium in the fermenter was adjusted to 6.4 by adding a 20% caustic solution of Ca(OH)₂ and NaOH (50/50 w/w ratio), followed by inoculation with 7.5% v/v (based on the end volume) of an inoculum containing B. coagulans (OD₅₀₀6-7).

Fermentation was conducted under anaerobic conditions and continuous stirring at a temperature of 54±2° C. The aforementioned caustic solution was used to maintain pH within the range of 6-6.8. The fed-batch material was gradually added in two hours, starting 12 hours after the start of the fermentation.

For each experiment, the time needed to reach a lactate concentration of 7.5% (w/v) is shown in Table 7.

TABLE 7

| | Fermentation time |
|---|---|
| Experiment | (hours) |
| 1 | 28 |
| 2 | 26 |
| 3 | 22 |
| 4 | 22 |

The reduction in fermentation time of the fed-batch onion/onion (Experiment 2) as compared to the batch onion experiment (Experiment 1) indicates that the onion juice stock contains components that retard the growth of the micro-organism, especially in the lag phase.

The results further show that in the fed-batch experiments using permeate 1a or glucose solution as the added substrate instead of the onion juice stock further reduced the fermentation time.

The fermentates obtained after completion of experiments 1-4 (lactate concentrations 8.0-8.2% w/v) were analysed to determine sugar concentrations (photometrically with the Gallery Discrete Analyzer, Thermo Scientific), nitrogen content (Kjeldahl) and phenolic compounds content (LCK345 kit, ex Hach Lange). Phenolic compounds were measured in the supernatant obtained after centrifugation (to remove turbidity). The results are shown in Table 8.

TABLE 8

| | Dry matter DM | Lactate | Phenolic compounds | Total N |
|---|---|---|---|---|
| Experiment | [%] | [% DM] | [% w/w] | [% w/w] |
| 1 | 13.3 | 61.7 | 0.14 | 0.216 |
| 2 | 13.3 | 60.5 | 0.14 | 0.201 |
| 3 | 12.9 | 62.0 | 0.14 | 0.202 |
| 4 | 12.1 | 69.3 | 0.085 | 0.116 |

Fed-batch experiments with permeate 1a and glucose lead to ferments with a higher lactate content.

### Example 3

To prepare an onion juice stock solution, 1 part by weight of onion juice concentrate was diluted with 2 parts by weight of demineralised water. Next, the diluted onion juice was UHT sterilised and cooled down to ambient temperature. The pH of the resulting medium was ˜4.6.

Next, the sterilized onion juice stock solution was filtrated in a crossflow lab membrane filtration set up (MMS, SW18-S) with 3 ultrafiltration membranes in series, each with a molecular weight cut-off of 5 kDa (Atech innovations GmbH, Al₂O₃/ZrO₂) at ambient temperature. The permeate was analysed to determine dry matter content, sugar concentrations (Ion exchange chromatography, Dionex Bio-LC), and phenolic compounds content (LCK345 kit, ex Hach Lange). The results are shown in Table 9.

TABLE 9

| | Permeate |
|---|---|
| Dry matter (DM) | 18.9% (w/w) |
| Glucose (g/kg) | 38.9 |
| Fructose (g/kg) | 45.0 |
| Sucrose (g/kg) | 16 |
| Total sugars (g/kg) | 99.9 |
| Total phenols (mg/kg) | 162 |

Both the onion juice feed and the onion juice permeate were treated with invertase 30 minutes prior to the start of fermentation, by adding 1 ml/kg of an invertase solution. Next, the invertase treated onion juice feed and onion juice permeate were fermented using Lactobacillus plantarum strain DSMZ 20174 (ordered from the DSMZ depository institution (German collection of microorganisms and cell cultures)).

The pH of the fermentation medium in the fermenter was adjusted to 6.8 by adding caustic solution of Ca(OH)₂ and NaOH (50/50 w/w ratio), followed by inoculation with 7.5% v/v (based on the end volume) of an inoculum containing L. plantarum (OD₅₀₀ 8-9). Besides the inoculum, yeast extract, vitamin and mineral mix and demineralized water was added.

Fermentation was conducted under anaerobic conditions and continuous stirring at a temperature of about 30° C. The aforementioned caustic solution was used to maintain pH at about 6.8.

For each experiment, the time needed to reach a lactate concentration of 4% (w/w) was determined. The results are shown in Table 10.

TABLE 10

| | Fermentation time |
|---|---|
| | (hours) |
| Feed | 18 |
| Permeate | 14 |

1. A fermented onion composition having a dry matter content of at least 8 wt. %, the composition comprising, per gram of dry matter:
(a) 75-800 mg acid equivalent of organic acid selected from propionic acid, lactic acid, acetic acid and combinations thereof;
(b) 2-200 mg acid equivalent of onion acid selected from selected from citric acid, malic acid, tartaric acid, oxalic acid, pyruvic acid, succinic acid and combinations thereof;
(c) 0-150 mg of saccharides selected from fructose, glucose, sucrose and combinations thereof;
(d) 0-40 mg of onion protein;
wherein the combination of (a) to (d) constitutes 50-95 wt. % of the dry matter in the composition.

2. The fermented onion composition according to claim 1, wherein the composition comprises per gram of dry matter 75-500 mg acid equivalent of organic acid selected from propionic acid, lactic acid, acetic acid and combinations thereof.

3. The fermented onion composition according to claim 1, wherein the composition comprises per gram of dry matter 200-800 mg lactic acid equivalent.

4. The fermented onion composition according to claim 1, wherein the composition comprises per gram of dry matter 75-800 mg propionate equivalent.

5. The fermented onion composition according to claim 1, wherein the composition comprises per gram of dry matter 120-450 mg acetate equivalent.

6. The fermented onion composition according to claim 1, wherein the composition comprises less than 5 mg onion protein per mg acid equivalent of the onion acid.

7. The fermented onion composition according to claim 1, wherein the composition comprises per gram of dry matter 0-2 mg of phenolic compounds.

8. The fermented onion composition according to claim 1, wherein the composition comprises per gram of dry matter:
(i) 0.05-30 mg acid equivalent of citric acid;
(ii) 0.2-30 mg acid equivalent of malic acid; and
(iii) 1-150 mg acid equivalent of gallic acid.

9. The fermented onion composition according to claim 1, wherein the composition comprises cellular material from lactic acid producing bacteria and/or propionic acid producing bacteria and/or acetic acid producing bacteria.

10. A method of preparing a fermented onion composition, the method comprising:
(a) providing an aqueous liquid having a dry matter content of 2-50 wt. %, wherein at least 80 wt. % of the dry matter is derived from onion;
(b) subjecting the aqueous liquid to membrane filtration using a membrane having a cut-off in the range of 200 to 2,000,000 Da to produce a permeate;
(c) fermenting the permeate with a micro-organism selected from lactic acid producing bacteria, propionic acid producing bacteria, acetic acid producing bacteria and combinations thereof.

11. The method according to claim 10, wherein at least 80 wt. % of the dry matter of the aqueous liquid is provided by onion juice and/or onion pulp.

12. The method according to claim 10, wherein the membrane has a cut-off of 1,000-500,000 Da.

13. The method according to claim 10, further comprising (d) subjecting the fermented permeate to membrane filtration using a membrane having a cut-off in the range of 200 to 2,000,000 Da.

14. A fermented onion composition obtained by the method according to claim 10.

15. A process of preparing a food product or a beverage, the process comprising combining the fermented onion composition according to claim 1 with one or more other ingredients.
